(19) United States
(12) Patent Application Publication
(10) Pub. No.: US 2025/0367691 A1
(43) Pub. Date: Dec. 4, 2025

(54) Bottle with removable dispenser

(71) Applicant: Adam Touzani, Houston, TX (US)

(72) Inventor: Adam Touzani, Houston, TX (US)

(21) Appl. No.: 18/731,275

(22) Filed: Jun. 1, 2024

(51) Int. Cl. B05B 11/00; B65D 1/02; B65D 51/28

(52) U.S. Cl. CPC B05B 11/0037; B65D 1/02; B65D 51/28; B65D 2543/00537

(57) ABSTRACT

A bottle comprising two open ended extremities including a storage chamber within which is located at least one concentrated product housed; a mixing chamber coupled to the storage chamber and capable of storing a pump dispenser assembly that must be removed through its threaded base opening before diluents are added.

### FIELD OF THE INVENTION

The present invention relates to a reusable bottle and in particular, to a bottle that is capable of housing internally a removable pump assembly.

### BACKGROUND OF THE INVENTION

This invention relates generally, to a bottle attached to a hand-operated dispenser or sprayer in which fluid or foam is dispensed from the bottle by a pumping or trigger action. Dispensers are typically provided with an internally threaded cap for securing the dispenser body to the neck of the bottle from which fluid is to be dispensed.

It is common for cleaner bottles with pump dispensers, such as trigger pump spray, to have the product pre-diluted for subsequent use. Once the spray bottle is empty, most users are inclined to throw the empty spray bottle away and purchase another diluted spray bottle, despite the fact that the empty spray bottle is still perfectly reusable and capable of dispensing more fluids. The problem of this type of ready-to-use containers, is that water constitutes 90% of the product's weight and volume, an element that can easily be added at home. Another problem related to plastics waste and its long term harm caused to the environment.

A preferred solution is to use a housing which contains a dissolvable concentrate of the primary ingredient of the product in conjunction with the bottle. In such a use the customer will fill the bottle to a given level with diluents such as water and release the concentrate potion. Housings for concentrates may include a cartridge, a packet, tablets or simply another small container that can be stored inside or outside the mixing chamber. Since pump dispensers have dip tubes which extend to the bottom of the bottle, the diluted product is now able to be dispensed upon actuation of the pump.

Pump based dispensers such as spray nozzles take up nearly half the vertical space of a salon size bottle. This waste of vertical space is necessary in order to accommodate a user's hand grip.

The prior art in this invention is exemplified by U.S. Pat. No. 11,969,745. This patent by the same inventors discloses a trigger pump in an upper part of a container that is removable and able to be inserted inside the bottle through the top end of the mixing chamber. The neck area of the bottle is itself removable in order to create the wide-mouth opening needed to insert the pump head assembly. This situation does not exist with the present invention since the wide-mouth opening is provided at the base of the bottle by way of the screw-on lid.

### SUMMARY OF THE INVENTION

The bottle of the invention defines two separate chambers: a storage chamber within which at least one concentrated product may be located; a mixing chamber within which the concentrated product may be mixed with diluents such as water, and two closure elements composed of a pump head assembly at one end, and a wide-mouth screw on lid at the base located at the opposite end of the bottle. The pump assembly is capable of been housed inside the mixing chamber and is removed through its base closure opening, to be screwed on the top of the bottle for normal use.

Viewed from the top, the bottle of the invention can have a cross section that is substantially round, oval, square or rectangular, while the storage chamber can be in the form of a secondary container that can be externally or internally connected to the mixing chamber.

The bottle opening at the its base must be wide enough to allow for the insertion of a hand pump dispenser such as a spray nozzle head and any concentrates or other accessories that may be required. One closure element of the container such s a spray head can connect to the threaded section at the top end of the bottle,, while the second closure element includes a wide mouth threaded screw-on lid located at the base open end of the bottle.

The pump dispenser must be placed inside the mixing chamber in a compact configuration when there is no diluents in the mixing chamber. This makes the bottle easier and less cumbersome to store, stack-up and transport. However, when it is ready for use, and before introducing any diluents, the pump assembly must be removed through its base opening and screwed-on in an up-right position to the narrow neck threaded section located at the top end of the bottle.

In the context of the present invention, the concentrated product may be in the form of a liquid, a gel or a solid, such as a powder, a cartridge or a tablet. Examples of liquid products that are provided or used in dispensers include, but are not limited to, soaps, shampoos, detergents, disinfectants, cleansers, hairspray, make-up, lotions, oils, scents, ointments, creams, antiperspirants, coloring products, medicines, skin care products, etc.

The reusable spray bottle may also be used without any concentrate, as common in a hair salon environment when water is continuously added for creating a mist.

In one embodiment of the invention, the mixing chamber is configured to receive a pump dispenser and a storage container for concentrates through its base cap opening.

In another embodiment of the invention, the mixing chamber is detachably coupled to the storage chamber at its base. For example, the storage chamber may be screwed on or it may be snap-fit onto the base lid of the mixing chamber. As such, the mixing chamber and the storage container are located on opposite sides of the screw-on base lid. An optional brush accessory is also included.

In another embodiment of the invention, the mixing chamber is detachably coupled to the storage chamber at its base. The storage chamber includes an inverted well that is substantially inserted upwardly inside the mixing chamber. The well is capable of housing a dedicated storage for the remaining concentrates even as the bottle is been used and without taking-up additional vertical space of the bottle.

A primary advantage of the new dispenser bottle is the economic and space savings realized during manufacturing, packaging, warehousing and shipping of concentrate packages rather than a diluted solution of active substances such as detergents. The advantage is the 30 to 50% space savings in storage, transport and shelving created by inserting the dispensing pump mechanism inside the mixing chamber and giving it access to be removed through the wide-mouth base opening only at time of use by the consumer.

The invention now being fully described, it will be apparent to one of ordinary skill in the art that many changes and modifications can be made thereto without departing from the spirit or scope of the invention set forth herein.

### BRIEF DESCRIPTION OF THE PREFERRED EMBODIMENTS

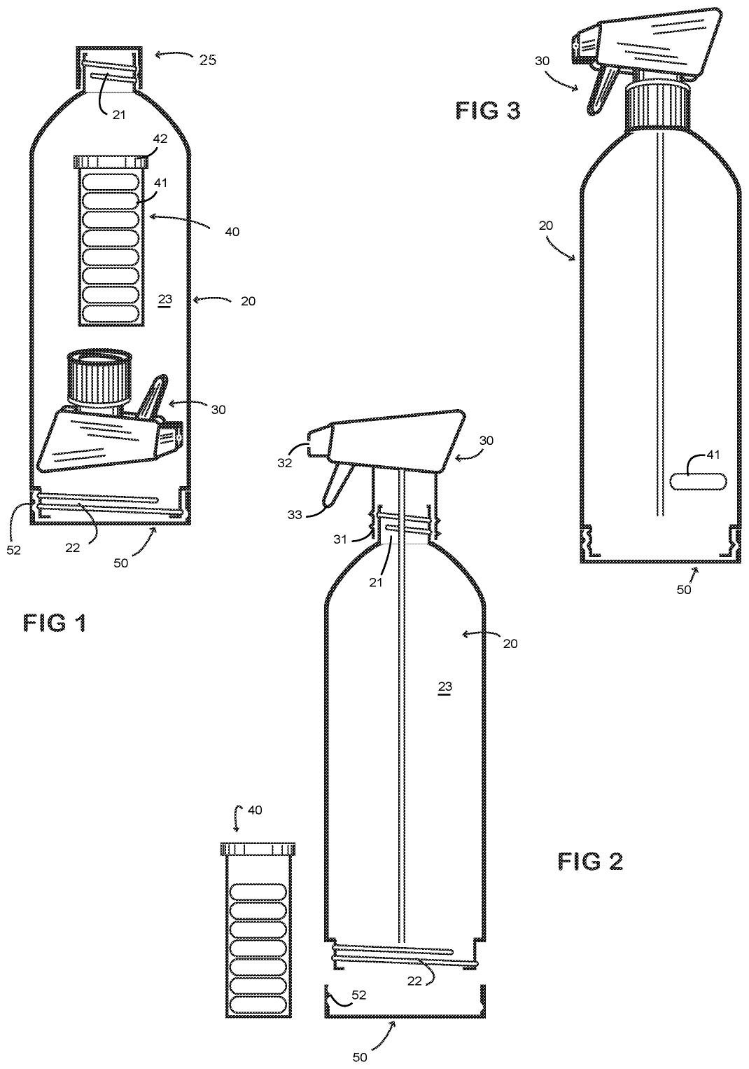

FIG. 1 is a front elevational cross section of a bottle-sprayer according to the invention in the collapsed storage position.

FIG. 2 is a front elevational cross section of a bottle-sprayer according to the invention with base closure open for removing the sprayer assembly.

FIG. 3 is a front elevational cross section of a bottle-sprayer according to the invention in the ready-to-use position including one single concentrated product.

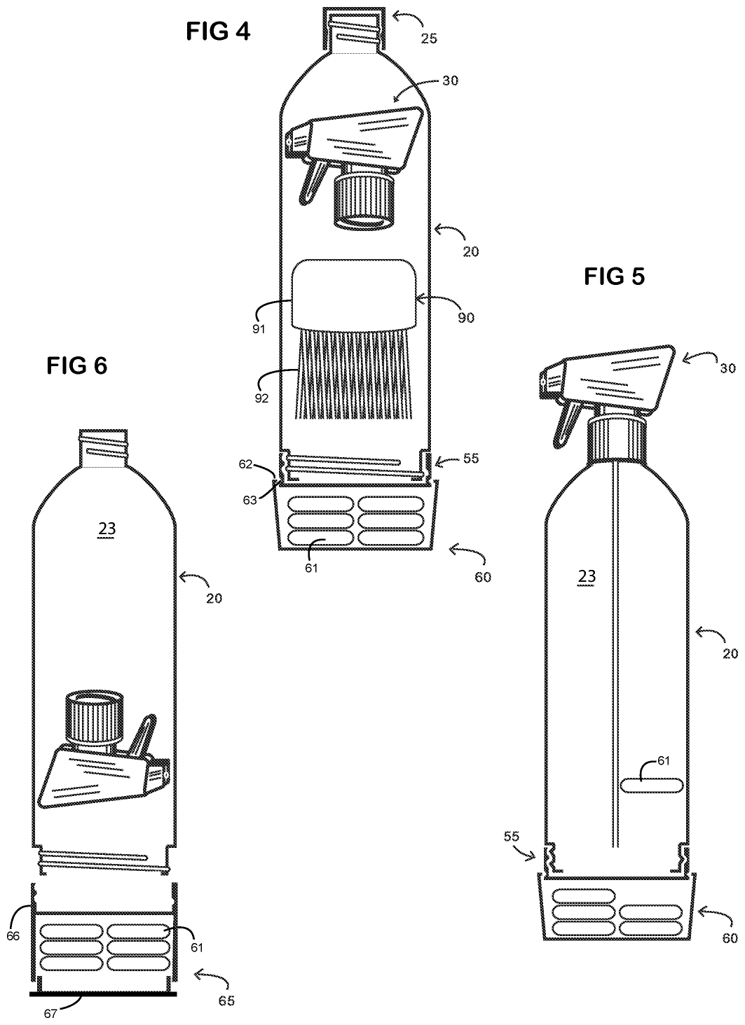

FIG. 4 is a front elevational cross section of a bottle-sprayer and brush accessory while screw-on base lid is attached to the storage chamber according to the invention, in the collapsed position.

FIG. 5 is a front elevational cross section of a bottle-sprayer with base attached concentrate storage according to the invention, in the ready-to-use position.

FIG. 6 is a front elevational cross section of a bottle-sprayer with base lid extended with a storage chamber according to the invention.

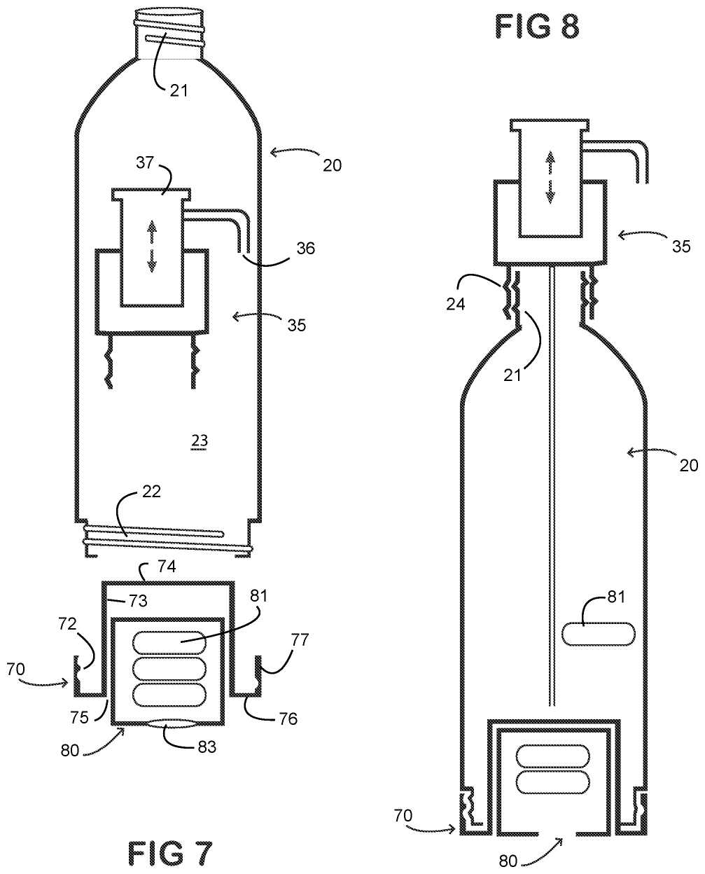

FIG. 7 is a front elevational cross section of a bottle with pump dispenser including a base cap comprised of an inverted well and a separate storage compartment.

FIG. 8 is a front elevational cross section of a bottle with pump dispenser including a base storage attachment comprised of an inverted well during use while the remaining concentrates are still stored.

### DESCRIPTIONS OF THE PREFERRED EMBODIMENTS

FIG. 1 shows bottle 20 according to a first embodiment of the invention comprises a mixing chamber 23 which is generally tubular in shape with a cross section that can be substantially round, oval, square or rectangular. The mixing chamber 23 is typically blow-molded or injection molded from a polymeric material such as PP, PVC or PET for clarity.

Detachable sealing cap 25 is in the form of a screw-on lid. The lid 25 includes a downwardly extending skirt, which defines a threaded portion on the inwardly facing wall of the skirt. The neck portion 21 of the mixing chamber 23 carries a complementary threaded portion, such that the closure element 25 may be screwed onto or unscrewed from the open top end 21 of the mixing chamber 23. Lid 25 is optional and may be used only in the mixing concentrates. Before spraying, lid 25 must be replaced by spray assembly 30.

FIGS. 1, 2 and 3 show a bottle 20 according to a first embodiment of the invention. The bottle comprises a mixing chamber 23 which is generally tubular in shape and which is open at both ends 21 and 22. The top end attaches to a pump head assembly such as a sprayer, while the second end allows for the removal of the sprayer assembly from inside the mixing chamber. Lid 50 is leak proof and must be screwed back on tight before any concentrates or diluents are added.

The storage chamber 40 is in the form of a removable container housing several concentrated products. Storage chamber 40 must remain outside the bottle while the mixing chamber contains diluents.

FIGS. 4 and 5 show base lid 55 and storage chamber 60 defined by a substantially cylindrical side wall, a closed bottom and one or more concentrate housings 61. The base lid 55 defines a threaded portion on its inwardly facing wall and a groove on the outer side of the lid skirt 63 for locking into storage chamber lip 62. The base of the mixing chamber 23 carries a complementary threaded portion 22, such that the storage chamber body 40 may be screwed onto or unscrewed from the base threaded section 22. The base lid 50 and the storage container 60 may connect through a threaded coupling or a snap-fit coupling.

The storage chamber 60 includes a plurality of sealed housings 61. A concentrated product is located within each of the housings. The skilled person will appreciate that instead of the housings comprising relatively rigid bodies, the housings may instead comprise sachets, capsules, cartridges or tablets, which contain the concentrated product.

In this embodiment, FIGS. 4 and 5 show the storage chamber body 60 need simply be separated from base lid 55 to be accessed. Base lid 55 also doubles as a cover for storage chamber 60. The brush accessory 90 may be housed alongside the pump assembly 30. Both the spray head and brush must be removed before any diluents are added. The concentrated product located within the housing may then be released into mixing chamber 23 to be mixed with diluents as described above.

FIG. 6 shows another embodiment where the storage chamber 65 is an extension of screw-on lid 66. Storage chamber cover lid 67 is used only to secure the remaining concentrated products.

FIGS. 7 and 8 show a bottle 20 comprises mixing chamber 23 which is similar to the mixing chamber shown in FIG. 1 through 5 and which is open at both ends with a threaded section.

The bottle 20 also includes a storage chamber 70 defined by a storage chamber body 73. The storage chamber body 70 includes a base portion 74 upwardly from which extends a cylindrical storage portion in the form of an inverted well, comprising a cylindrical side wall 73, which has a closed top 74 and an open bottom 75. Upwardly extending from a peripheral edge portion of the base portion 76 is a skirt 77. The skirt 77 carries a threaded portion 72 on its inwardly facing wall. The bottom end 22 of the mixing chamber 23 carries a complementary threaded portion 22, such that the storage chamber body 70 may be screwed onto or unscrewed from the open bottom end 72 of the mixing chamber 22. The storage chamber body 70 further includes a sliding plug 80 which selectively closes or opens the open bottom end 75 of the cylindrical well portion. As noted above, the tight-fit plug 80 may include a circular aperture through which a user's finger may be located 83 to permit an downward force to be exerted on the snap-fit plug 80 in order to remove it.

As with the preceding embodiment, the storage chamber defined by the storage chamber body 80 includes a plurality of sealed housings 81. A concentrated product is located within each of the housings 81. The skilled person will appreciate that instead of the housings comprising relatively rigid bodies closed with sealing films, the housings may instead comprise sachets which contain the concentrated product.

The bottle 20 is assembled by removing pump head assembly 35 before screwing the storage chamber body 70 to the open bottom end 22 of the mixing chamber 23 and by screwing the attached pump head assembly 35 to the open top end 21 of the mixing chamber 23. The snap-fit plug 80 can be removed and one of the housings 81 is picked from the cylindrical storage portion. The snap-fit plug 80 is then replaced back. The closure element 25 (not shown) is unscrewed from the mixing chamber 23 and the concentrated product from the housing 81 and diluents are added to the mixing chamber 23. The closure element 25 (not shown) is then replaced with dispenser head 35 onto the top section 21 of the mixing chamber and the concentrated product is added with the diluents.

It will be noted that the storage chamber body 80 need not be stored separately from the mixing chamber 23 in order to use the bottle 20 in this embodiment.

As various changes could be made in the above construction without departing from the scope of the invention, it is intended that all matter contained in the above description or shown in the accompanying drawings shall be interpreted as illustrative and not in a limiting sense. The invention therefore shall be limited solely by the scope of the claims set forth below.

1- A bottle including a storage chamber within which is located at least one concentrated product; a mixing chamber coupled to the storage chamber; the mixing chamber is defined by a body having a longitudinal length defined between opposed first and second open ends, and comprising inside one removable pump dispenser assembly with a dip tube.

2- A bottle of claim 1, wherein a mixing chamber is capable of connecting a pump dispenser to its threaded top narrow opening, while the second open end of the mixing chamber includes a threaded section and allows for the removal of the pump dispenser.

3- A bottle of claim 2, wherein a base closure element in the form of a screw-on lid is able to be screwed back on before any diluents are added to the mixing chamber.

4- A bottle of claim 2, wherein the mixing chamber can house both the dispenser head and multiple concentrated products.

5- A bottle of claim 2, wherein the storage chamber is attached to the base closure element.

6- A bottle of claim 5, wherein the base closure element defines a well which is configured to receive a container which contains the concentrated product.

7- A bottle of claim 5, wherein the base closure element includes an internally facing surface and an externally facing surface and the well is open at the externally open surface.

8- A bottle according to any of claims 4 to 6, wherein the storage chamber is coupled to the second end of the mixing chamber.

9- A bottle according to any of claims 4 to 6, wherein the storage chamber or a further storage chamber is defined within the base closure element.

10- A bottle for mixing concentrated products comprising two open ended extremities; a mixing chamber capable of storing a pump dispenser assembly; whereas pump assembly can be removed through its threaded base opening.

11- A bottle of claim 10, wherein a mixing chamber is capable of connecting a pump dispenser to its threaded top narrow opening, while the second open end of the mixing chamber includes a threaded section and allows for the removal of the pump dispenser.

12- A bottle of claim 11, wherein a base closure element in the form of a screw-on lid is screwed back on before any diluents are added to the mixing chamber.

13- A bottle comprising a mixing chamber with two open-ended extremities coupled to the storage chamber and capable of storing a pump dispenser assembly; wherein the storage chamber for concentrates is attached internally or externally to a closure element located at the base of the bottle in the form of a screw-on sealing cap.
